(19) United States
(12) Patent Application Publication
(10) Pub. No.: US 2008/0132813 A1
(43) Pub. Date: Jun. 5, 2008

(54) Training Device

(76) Inventor: Jiro Katsuta, Krefeld (DE)

Correspondence Address: BERENATO, WHITE & STAVISH, LLC, 6550 ROCK SPRING DRIVE, SUITE 240, BETHESDA, MD, 20817, US

(21) Appl. No.: 11/718,949

(22) PCT Filed: Oct. 19, 2005
(86) PCT No.: PCT/EP05/11214

§ 371 Date: Aug. 22, 2007

(30) Foreign Application Priority Data
Nov. 10, 2004 (EP) 04026670.2

(51) Int. Cl. A61H 7/00

(52) U.S. Cl. 601/49

(57) ABSTRACT

The invention relates to a method for training muscle groups of a human being, whereby vibrations are introduced into the body of the human being by means of at least one vibration plate (8), characterized in that a person (6) is positioned to lie in a horizontally-arranged vacuum chamber (4), such that at least one part of the body of the person (6) for training is outside the vacuum chamber (4) and the feet of the person (6) contact the vertically-arranged vibration plate (8) in the vacuum chamber (4), a pressure below the atmospheric pressure is produced in the vacuum chamber (4), such that the person (6) is drawn against the vibration plate (8) and the vibration plate (8) is made to oscillate and the oscillations generated are introduced into the body of the person (6). The invention further relates to a device for training muscle groups of a human being.

The present invention relates to a method for training a person's muscle groups, wherein vibrations are introduced into the body of a person by means of at least one vibration plate. Moreover the invention relates to an apparatus for training a person's muscle groups with a vibration unit with at least one vibration plate, at least one vibration producer for introducing vibrations into the vibration plate, and at least one control unit for controlling the vibration amplitude of the vibration plate.

A method an apparatus of the type specified above are known, for example, from WO 02/053084 A1. This document discloses an apparatus for stimulating a human body by means of vibrations which has a base platform on which a vibration plate in the form of an oscillating rocker is disposed. For training purposes the person stands on the vibration plate, and he can hold onto two handles which are fitted onto the base platform to the side of the vibration plate. If the vibration plate is now caused to vibrate, with a low amplitude and frequency these vibrations are conveyed via the soles of the person's feet into the lower body and trigger a muscle reflex here. The muscle groups in the region of the calves, the thighs and/or the hips are thus stimulated.

It is considered to be a disadvantage with this system that the training must be carried out with the person in the upright standing position because, on the one hand, only by means of the person's own weight can a continuous contact be maintained between the vibration plate and the person's feet, and on the other hand the vibration plate must be in constant contact with the base in order to be able to introduce the vibrations.

It is therefore the object of the present invention to provide a method and an apparatus of the type specified at the start which also makes it possible to carry out training by introducing vibrations to people in a lying position.

This object is fulfilled according to the invention in a method of the above specified kind in that a person is positioned in a horizontally directed vacuum chamber in such a way, that at least a body section of the training person is outside of the vacuum chamber and the feet of the training person are in contact with the vibration plate, which is arranged up right in the vacuum chamber, that subsequently a pressure below ambient pressure is set in the vacuum chamber, so that the person is drawn against the vibration plate, and that the vibration plate is put into vibrations and the produced vibrations are introduced into the body of the person.

The invention is therefore based upon the notion of producing the force required to introduce vibrations into a person to be trained in the direction of the vibration plate by means of a pressure lying below ambient pressure so that it is also possible to introduce vibrations to a person in an inclined position, and that by taking appropriate measures the vibrations are also introduced into the person's body without constant contact with the ground, and parasitic vibrations are prevented by appropriate vibration elimination as they are conveyed on to the frame.

Furthermore, due to the pressure lying below ambient pressure, blood is collected in the part of the body located in the vacuum chamber, by means of which the whole circulation of the person is stimulated and the vegetative nervous system is activated. The activity in the sympathetic branch of the nervous system is increased, and both the frequency and the contraction force of the heart is increased. Furthermore, lymph in the region subjected to pressure lying below ambient pressure is re-distributed. Lymphatic or interstitial fluid of the skin is mobilised in the subcutis and re-distributed by the stimulated circulation. Finally, the intercellular volume is increased, and the micro- and macro blood circulation increased in the lower limbs. The plasma volume is also increased by reflexes of the vegetative nervous system. In this way, for example, a fluid balance disrupted by a long time spent lying down due to illness or a disrupted circulatory system of the person to be trained can be stabilised and a new type of lymph drainage treatment can be carried out. The method according to the invention can correspondingly also be used for the treatment of metabolic disruptions, overweight and cellulitis or also for stimulating the circulation.

In order to obtain an optimal training result, the invention proposes detecting the pressure set in the vacuum chamber and the vibration amplitude of the vibration plate by means of sensors and co-ordinating these with one another by means of a control unit. This can be achieved, for example, by the vibration amplitude of the vibration plate being set dependently upon the pressure prevailing in the vacuum chamber. In addition, during use the pressure can pulsate such that the method or the apparatus according to the invention acts as an external lymph flow stimulator.

The individual muscle groups are preferably trained in application cycles, an application cycle comprising setting the pressure below ambient pressure in the vacuum chamber and producing vibrations in a pre-specified vibration cycle. One application cycle can last up to 4 minutes, the vibration cycle being started directly after reaching the maximum pressure to be set below ambient pressure. Over the whole application cycle, the pressure in the vacuum chamber is at no time greater than ambient pressure.

A preferred embodiment of the invention proposes setting a pressure differential of up to −60 mmHG (−8 kPa) below ambient pressure at the start of an application cycle, and constantly raising the pressure from this level during the application cycle so that a saw tooth-like pressure progression is set during treatment. Due to the differences in elasticity of the skin, the musculature and the vein walls adjacent to the deep-seated arteries, this pressure progression mobilises blood and lymph fluid at different pressures. The vein walls close to the surface of the skin are more stable and less flexible than the more elastic regions deep down such as e.g. in the centre of the leg cross-section. Furthermore, the skin in the region of the ankle is more stable than for example the skin at the level of the hip. As pressure decreases, the elastic veins deep down are first of all distended. Blood and lymph fluid are thus re-distributed from the skin into the deep-seated vessels. As the pressure difference increases, at −60 mmHG (−8 kPa) veins and lymph vessels are finally also distended in the region of the feet, by means of which blood and lymph fluid are distributed towards the feet. When the pressure difference decreases in the vacuum chamber, blood and lymph fluid move towards the heart. Since flaps which act as valves are located in the veins and lymph vessels, blood and lymph are re-distributed by the pressure pulsation and are massaged gently towards the heart.

One preferred embodiment of the present invention proposes producing the vibrations cyclically, in particular with a frequency of 15 to 25 Hz, one vibration cycle lasting up to 2 minutes. Depending upon the physical condition of the person to be trained, a full training session can include between two and eight application cycles.

By stimulating the circulation and the metabolism, heat is produced. For cooling purposes a flow of air can be conveyed through the vacuum chamber. This is advantageously kept constant despite changing pressure ratios in the vacuum chamber. For this the outflowing flow of air is measured taking into account a leakage flow which may occur, for example, at the transition regions between the person to be trained and the vacuum chamber. The supply of air is correspondingly controlled by a throttle valve, the cross-section of which can be variable, such that the whole flow of air remains approximately constant. In this way, the heat which is produced during the patient's training can be discharged. Furthermore, the outflowing flow of air can be used in order to cool electronic components outside of the vacuum chamber and to prevent the latter from over-heating.

In order also to be able to guarantee the stability of the organism of the person to be trained during training, it is proposed in one exemplary embodiment to measure and check the person's vital parameters such as heart rate, blood pressure correlation and muscle output during the whole training session.

A further exemplary embodiment of the present invention proposes supplementing and supporting the muscle invigoration by introducing vibrations into the person by means of an electrical muscle stimulation device. For this electrical current impulses are used which bring about a contraction of the muscle fibres. The electrical current introduced into the body by means of electrodes enables more targeted contraction of individual muscle sections—also called electrical muscle stimulation (EMS). By contracting the muscle groups blood flow and metabolism are increased so that individual muscles are strengthened and fat can be broken down in specific problem areas.

According to the invention a weak beta ray emitter can be used (minus ion therapy) in order to be able to further increase the circulation of blood through the skin by ionisation. As well as stimulation of the blood circulation and metabolism of the skin, by means of this method the regenerative capabilities of the skin cells are also stimulated.

In order to carry out the above mentioned method, the apparatus according to the present invention is provided with at least one vibration plate, at least one vibration producer for introducing vibrations into the vibration plate, and at least one control unit for controlling the vibration amplitude of the vibration plate, wherein the vibration plate is disposed upright in a vacuum chamber with an access opening through which the person to be trained can be positioned in a horizontal position in the vacuum chamber such that he projects with at least one body section from the access opening of the vacuum chamber, and his feet come into contact with the vibration plate in the vacuum chamber, it being possible to set a pressure lying below the ambient pressure in the vacuum chamber so as to draw the person onto the vibration plate and to hold him on the vibration plate.

In order to seal the internal space of the vacuum chamber from the ambient pressure, an elastic sleeve can be provided at the access opening of the vacuum chamber which can be easily adapted to the body of the person to be trained which is to be enclosed due to manually changeable pre-tensioning in its elasticity, enabled for example by an iris.

In order to produce vibrations without transferring parasitic vibrations to the housing, in one exemplary embodiment the vibration producer has an intermediate mass which is suspended resiliently in a housing of the vibration producer, is coupled to the vibration plate and caused to vibrate by the vibration producer. This intermediate mass can vibrate out of phase with the vibration plate.

In order to take into account variable parameters such as for example the mass of the person to be trained, in the apparatus according to the invention the intermediate mass and the vibration plate can in particular be coupled to one another by means of plunger coil magnets such that the ratio of their vibration amplitudes to one another can be adjusted. In this way the amplitude of the intermediate mass can be adapted to the mass of the masses of the person to be trained which are to be vibrated. If the weight of the person to be trained is for example 40 g and the weight of the intermediate mass is 8 kg, according to the momentum conservation law a coupling is desirable which enables a vibration ratio of intermediate mass to vibration plate of 5:1.

In a further embodiment of the present invention, in order to support the transfer of the vibrations of the intermediate mass to the vibration plate, an electrically generated magnetic field can be applied to the coils. The current can be conveyed through the springs of the suspension.

In a further exemplary embodiment of the apparatus according to the invention means are provided in the vibration producer in order to be able to adapt the apparatus to any uneven leg lengths of the person to be trained.

In order to avoid any remaining parasitic vibrations between the vacuum chamber and the vibration producer, damping elements can be inserted between them.

One preferred embodiment of the apparatus according to the invention provides two separate vibration plates which form systems running counter to one another within the apparatus and which can be operated such that they alternately act upon and relieve the person's legs. The vibration plates can for example be in the form of magnetically driven linear oscillators. By means of the alternating action it is possible for the musculature of both legs to be subjected alternately during the training session to both action and release phases so that a good training results can be achieved without there being any risk of over-working the musculature.

A variation of this embodiment proposes that the two vibration plates are coupled by means of a lever mechanism and can be moved together in opposite directions. This lever mechanism can be flexibly supported on a prop, in particular by an intermediate piece, fixed to the vacuum chamber, the prop absorbing the compressive forces being exerted upon the vibration plates.

In this exemplary embodiment the vibration plates can be supported elastically by leaf springs on the lever mechanism and/or in a fixed position. The advantage of this type of support is that only one flexible connection is provided in the whole vibration system between the lever mechanism and the prop fixed onto the vacuum chamber. The lever mechanism can also be resiliently supported by leaf springs or similar on the coupling element of the vibration producer and/or on the vibration unit.

A further variation proposes that a vibration producer is respectively allocated to the two vibration plates, the vibration produces being coordinated with one another such that they stimulate the vibration plates in direct contact alternately and in opposite directions.

Because in this exemplary embodiment the compressive forces exerted upon the vibration plates can not be absorbed by a prop, with this embodiment a base mass is advantageously provided in the vibration producers which is coupled to the intermediate mass by springs, it being possible to change the pre-tensioning of the springs by moving the base mass. If the position of the intermediate masses is relocated due to compressive forces which act upon the vibration plates, this position relocation can be equalised by changing the pre-tensioning of the springs. This movement of the base mass can be implemented for example with the help of a hydraulic system by means of which the pre-tensioning of the springs can be adjusted in accordance with the compressive forces exerted upon the vibration plates, for example in order to achieve a desired vibration amplitude.

Furthermore, by means of this relocation possibility, the position of the vibration plates can be adapted separately to each leg of the person to be trained.

In order to be able to adapt the apparatus according to the invention to the different body sizes and leg lengths of the people to be trained, a further exemplary embodiment proposes that the chamber housing of the vacuum chamber and/or a lying surface for the people to be trained disposed in the vacuum chamber can be relocated separately from the vibration unit.

With regard to further advantageous embodiments of the present invention, reference is made to the sub-claims and to the attached drawings. These show as follows:

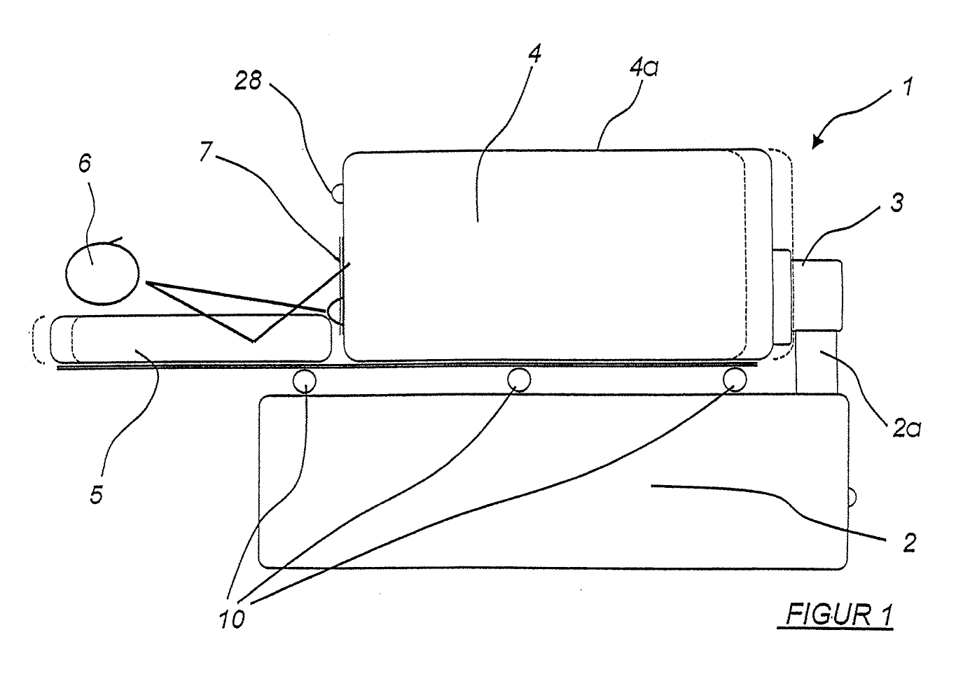

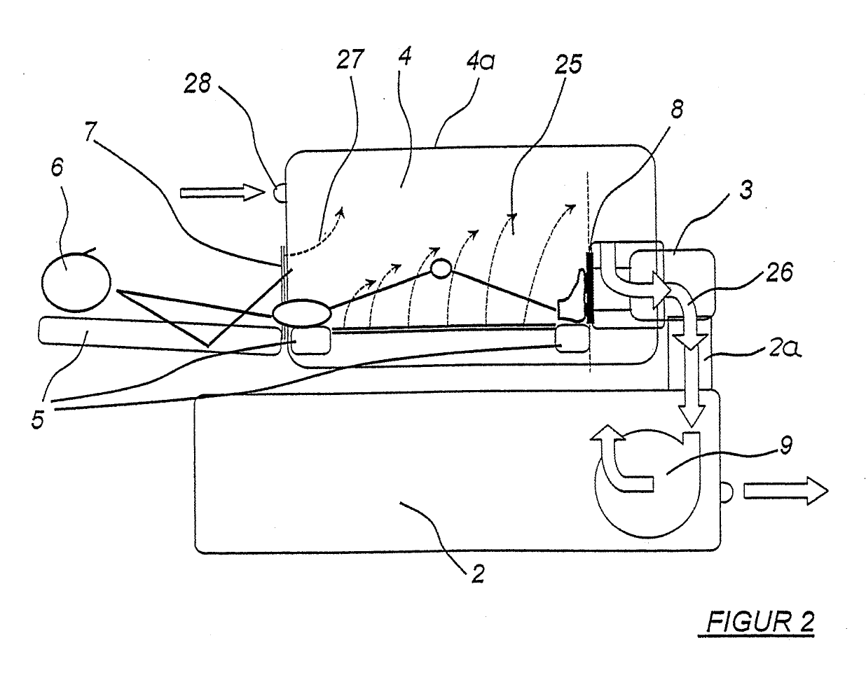

FIG. 1 a schematic side view of an apparatus according to the invention for training a person's muscle groups;

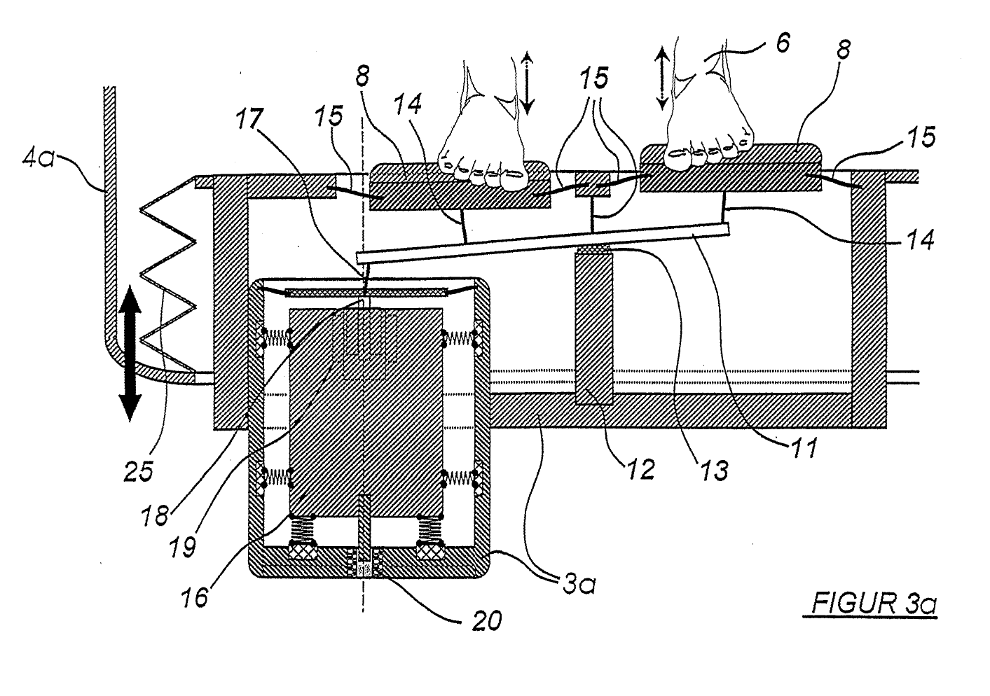

FIG. 2 a part-section of the apparatus according to the invention according to FIG. 1;

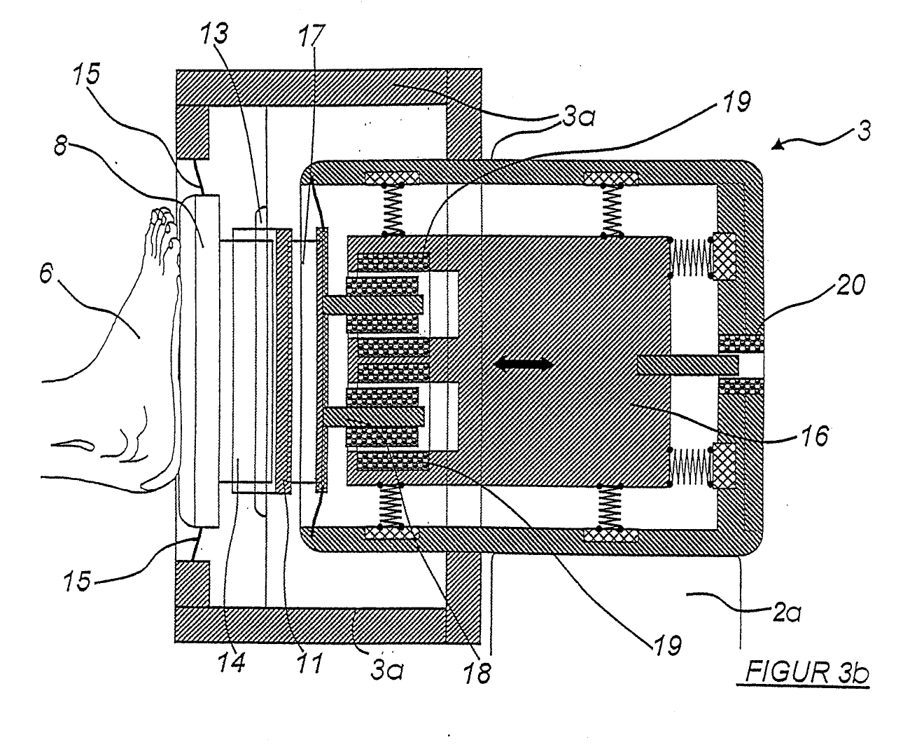

FIG. 3a a sectional illustration along section line I-I in FIG. 2;

FIG. 3b a sectional illustration along section line II-II in FIG. 3a;

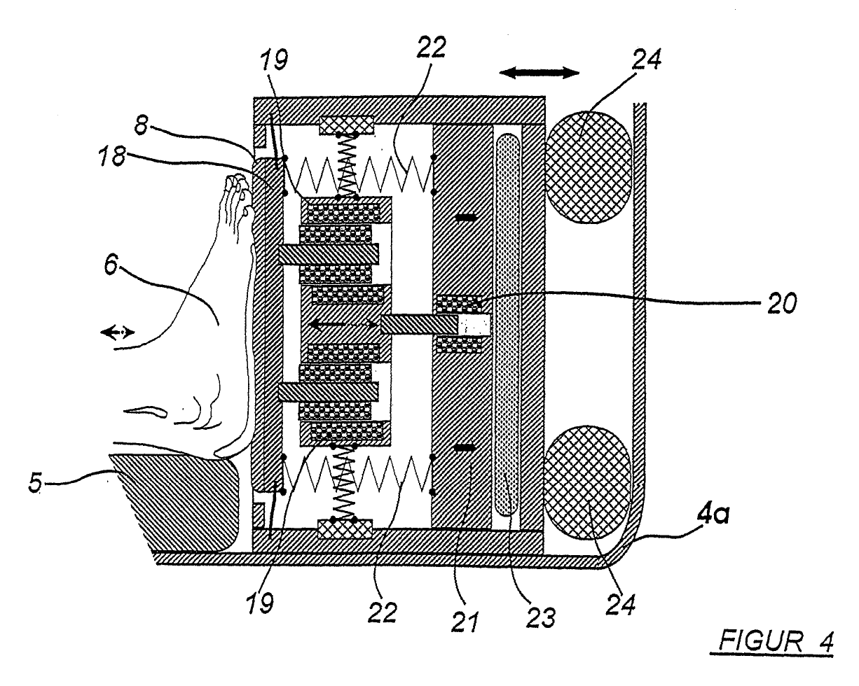

FIG. 4 an illustration of a part cross-section through an alternative exemplary embodiment of the apparatus according to the invention; and

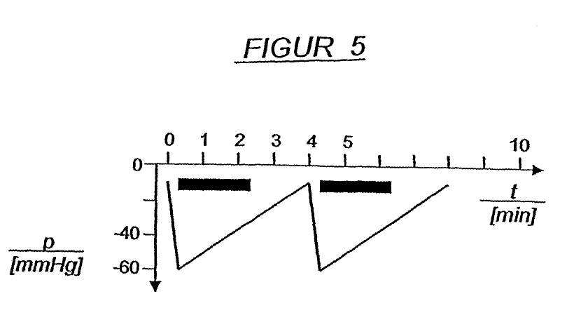

FIG. 5 a schematic illustration of the pressure progression of two application cycles according to the invention dependently upon time.

FIGS. 1 and 2 show an apparatus 1 according to the invention for training a person's muscle groups.

The apparatus 1 has a frame 2 onto which a vibration producer 3 and a vacuum chamber 4 are fitted, the vibration producer 3 partially projecting into the vacuum chamber 4. Furthermore, a lying surface 5 is installed in the vacuum chamber 4. A person 6 to be trained is positioned via an access opening 7 in the vacuum chamber 4 with his lower body in a horizontal position such that the feet of the person 6 to be trained are in contact with a vibration plate 8 disposed upright in the vacuum chamber 4 and fitted onto the vibration producer 3. In order to produce a pressure lying below ambient pressure, a generator 9 connected to the vacuum chamber 4 is provided in the frame 2. The vibration producer 3 is connected securely to the frame 2 by means of a mounting 2a.

Disposed beneath the vacuum chamber 4 and the outer limit of the lying surface 5 in FIG. 1 rollers 10 are disposed by means of which the housing 4a of the vacuum chamber 4 and the lying surface 5 disposed in the vacuum chamber 4 can be relocated to adapt the apparatus to the body size and leg length of the person 6 to be trained. In FIG. 1, for example, different settable positions are shown by the dashed lines.

In FIGS. 3a and 3b an exemplary embodiment of the apparatus 1 according to the invention is shown which has two vibrations plates 8 separated from one another and which form counter-running systems within the apparatus 1 and can be operated such they alternately act upon and relieve the legs of the person 6 to be trained, as indicated by the arrows. By relocating the vacuum chamber 4 the vibration producer 3 can be adapted to different leg lengths. The length equalisation by the vacuum chamber is implemented by means of bellows 25 as shown in FIG. 3a.

The two vibration plates 8 are coupled by means of a lever mechanism 11 and can be moved by the latter at the same time in opposite directions. The lever mechanism 11 is supported flexibly on a prop 12 by means of an intermediate piece 13 made of rubber. The prop 12 and the intermediate piece 13 serve, among other things, to absorb the compressive forces exerted upon the vibration plates 8. The coupling of the vibration plates 8 and the lever mechanism 11 is realised here by means of leaf springs 14, but other types of coupling known from the prior art are also conceivable. In this exemplary embodiment the vibration plates 8 and the lever mechanism 11 are additionally elastically suspended in a fixed position. In order to introduce vibrations via the lever mechanism 11 into the vibration plates 8 the vibration producer 3 has an intermediate mass 16 which is suspended resiliently in a housing 3a of the vibration producer 3 and is coupled by the lever mechanism 11 to the vibration plates 8. For this the vibration producer 3 has a coupling element 18 connected to the lever mechanism 11 by means of a leaf spring 17 which in turn can be magnetically coupled to an intermediate mass 16 by means of a plunger coil magnet system 19.

The intermediate mass 16 and the lever mechanism 11 are coupled to one another such that the ratio of their vibration amplitudes to one another can be adjusted. In order to produce vibrations the resiliently suspended intermediate mass 16 can first of all be caused to vibrate by a plunger coil magnet system 20. The coupling to the lever system is implemented by means of the plunger coil magnet system 19. The ratio of the vibration amplitudes of the plunger coil magnet systems 19, 20 to one another is adjustable. In this way the amplitude of the intermediate mass 16 can be adapted to the mass of the person 6 to be trained. If the weight of the mass to be vibrated of the person to be trained 6 is for example 40 kg and the weight of the intermediate mass 16 is eight kg, according to the momentum conservation law a coupling is desirable which enables a vibration ratio of the intermediate mass 16 to the vibration plate 8 of 5:1.

FIG. 4 shows an alternative exemplary embodiment of the apparatus 1 according to the invention in which a vibration producer 3 is respectively allocated to the two vibration plates 8, the vibration producers 3 being co-ordinated with one another such that they stimulate the vibration plates 8 in direct contact alternately and in opposite directions. In the vibration producer 3 a base mass 21 is provided which is coupled to the vibration plate 8 by springs 22 and by means of its relocation it being possible to change the pre-tensioning of the springs 22 between the base mass 21 and the vibration plate 8. If the position of the vibration plate 8 is now relocated due to compressive forces which act upon the vibration plates 8, this position relocation can be equalised by changing the pre-tensioning of the springs 22.

This relocation of the base mass 21 can be implemented, for example, with the help of a hydraulic system 23 by means of which the pre-tensioning of the springs 22 can be adjusted according to the compressive forces exerted upon the vibration plates 8.

In order to avoid parasitic vibrations, additional damping elements 24 are provided between the vacuum chamber 4 and the vibration producer 3. At the same time they can work as a second hydraulic system by means of which a relocation possibility for each vibration plate 8 can be realised for the purpose of each system being able to be adapted separately to the length of the respective leg of the person 6 to be trained.

In order to train a person's various muscle groups, the person 6 to be trained is placed in the reclined position in the horizontally aligned vacuum chamber 4 such that the upper body of the person 6 to be trained is located outside of the vacuum chamber 4. The feet of the person to be trained come into contact here with the vibration plates 8 disposed vertically in the vacuum chamber. Next a pressure lying below ambient pressure is set in the vacuum chamber 4 so that the person 6 is drawn towards the vibration plates 8 and held against them due to the pressure in the vacuum chamber lying below ambient pressure. After this the vibration plate 8 is caused to vibrate and the vibrations thus produced are conveyed via the soles of the feet of the person's 6 body so that a muscle reflex is triggered here and the muscle groups in the region of the calves, the thighs and/or the hips are stimulated.

The muscle groups are trained in application cycles, one application cycle comprising setting the pressure below ambient pressure in the vacuum chamber 4 and producing vibrations in a pre-specified vibration cycle. One application cycle lasts up to 4 minutes, the vibration cycle being started immediately after reaching the maximum pressure differential to be set.

In FIG. 5 the pressure progression of two application cycles is shown dependently upon time. At the start of an application cycle a pressure of up to −60 mmHG (−8 kPa) below ambient pressure is set. The pressure is then constantly linearly increased from this level during the application cycle so that a saw tooth-type pressure progression is set. The pressure in the vacuum pressure 4 is at no time greater than ambient pressure during an application cycle. The vibrations are produced cyclically with a frequency of between 15 and 25 Hz, a vibration cycle such as that shown by the black bars in FIG. 5 starting when the maximum pressure differential is reached and lasting up to 2 minutes.

In FIGS. 3a and 3b the two vibration plates 8, which can be operated to run counter to one another, are alternately caused to vibrate in the vacuum chamber 4 in order to introduce vibrations into the leg of the person 6 to be trained allocated to the respective vibration plate 8. For this a common vibration producer 3 stimulates the vibration plates 8 coupled to one another by a resiliently suspended lever mechanism 11.

According to FIG. 2 a flow of air 25 (shown by the dashed arrows) is passed through the vacuum chamber 4. The flow of air 25 serves to cool the person 6 to be trained located in the vacuum chamber 4 during the whole training session. In order to keep this flow of air 25 constant, even when there are changing pressure ratios in the vacuum chamber 4, the flow of air 26 passing out of the vacuum chamber 4 is measured, taking into account the leakage air 27 that occurs at the access opening 7, and the supply of air is adapted to the flow of air 9 passing out by means of a throttle valve 28. The flow of air 26 passing out of the vacuum chamber 4 is conveyed through the vibration producer 3, as shown in FIG. 2, in order to additionally cool the latter. In this exemplary embodiment the flow of air 26 is controlled by means of a throttle valve 28 the cross-section of which is changeable. The air sucked in by this throttle valve is conveyed in an appropriate manner to outlet openings in the lying surface 5 within the vacuum chamber. The pressure in the vacuum chamber 4 is controlled by a speed controller in the generator 9.

Furthermore, during the whole training session the person's vital parameters such as heart rate, blood pressure correlation and muscle output are continuously measured and checked.

1. (canceled)

2. (canceled)

3. (canceled)

4. (canceled)

5. (canceled)

6. (canceled)

7. (canceled)

8. An apparatus (1) for training a person's muscle groups with
at least one vibration plate (8),
at least one vibration producer (3) for introducing vibrations into the vibration plate (8), and
at least one control unit for controlling the vibration amplitude of the vibration plate (8),
characterised in that the vibration plate (8) is disposed upright in a vacuum chamber (4) with an access opening (7) through which a person (6) to be trained can be positioned in a horizontal position in the vacuum chamber (4) such that he projects with at least one body section from the access opening (7) of the vacuum chamber (4), and his feet come into contact with the vibration plate (8) in the vacuum chamber (4), it being possible to set a pressure lying below the ambient pressure in the vacuum chamber (4) so as to draw the person (6) onto the vibration plate (8) and to hold him on the vibration plate (8).

9. The apparatus (1) according to claim 8, characterised in that the vibration producer (3) has an intermediate mass (16) which is carried in a housing (3a) of the vibration producer (3) and is coupled to the vibration plate (8), and which can be caused to vibrate by stimulation means, the intermediate mass (16) and the vibration plate (8) being coupled to one another, in particular by means of plunger coil magnets (19, 20) such that the ratio of their vibration amplitudes to one another can be adjusted.

10. The apparatus (1) according to claim 9, characterised in that it has two separate vibration plates (8) which form systems running counter to one another within the apparatus (1) and which can be operated such that they alternately apply and release a load to/from the legs of the person to be trained (6).

11. The apparatus (1) according to claim 10, characterised in that a vibration producer (3) is respectively allocated to the two vibration plates (8), the vibration producers (3) being co-ordinated with one another such that they stimulate the vibration plates (8), which are in direct contact, alternately and in opposite directions.

12. The apparatus (1) according to claim 13, characterised in that in the vibration producers (3) a base mass (21) is respectively provided which is coupled by springs (22) to the vibration plate (8), it being possible to change pre-tensioning of the springs (22) between the base mass (21) and the vibration plate (8) by moving the base mass (21), and a hydraulic system being provided in the vibration producer for moving and/or supporting the base mass (21).

13. The apparatus according to claim 10, characterized in that the two vibration plates (8) are coupled by means of a lever mechanism (11) and can be moved together in opposite directions, the lever mechanism (11) being flexibly supported, in particular on a prop (12), in particular by an intermediate piece (13) made of rubber, the prop (12) absorbing compressive forces exerted on the vibration plates (8), and transferring them via the housing (3a) and via a mounting (2a) onto the frame (2).
